(19) United States
(12) Patent Application Publication
(10) Pub. No.: US 2024/0383203 A1
(43) Pub. Date: Nov. 21, 2024

(54) Three-Dimensional Shaping Apparatus

(71) Applicant: SEIKO EPSON CORPORATION, Tokyo (JP)

(72) Inventors: Akihiko TSUNOYA, Okaya (JP); Takayuki YOKOYAMA, Matsumoto (JP)

(21) Appl. No.: 18/663,653

(22) Filed: May 14, 2024

(30) Foreign Application Priority Data
May 15, 2023 (JP) 2023-079902

(51) Int. Cl. B29C 64/336; B29C 64/165; B29C 64/357; B33Y 30/00

(52) U.S. Cl. CPC B29C 64/336; B29C 64/165; B29C 64/357; B33Y 30/00

(57) ABSTRACT

A three-dimensional shaping apparatus includes a casing having a first connector and a second connector, a shaping stage on which a powder layer is formed, a layer forming unit that forms a powder layer, a first carriage that moves the layer forming unit, a shaping head that discharges a liquid containing a binder onto the powder layer, a liquid storage unit that stores the liquid, a supply pipe that couples the liquid storage unit and the shaping head, a second carriage that moves the shaping head, a first cable that couples the first connector and the layer forming unit, and a second cable that couples the second connector and the shaping head, wherein the supply pipe has a first turn-around portion, the first cable has a second turn-around portion, and a radius of curvature of the first turn-around portion is larger than a radius of curvature of the second turn-around portion.

The present application is based on, and claims priority from JP Application Serial Number 2023-079902, filed May 15, 2023, the disclosure of which is hereby incorporated by reference herein in its entirety.

### BACKGROUND

### 1. Technical Field

The present disclosure relates to a three-dimensional shaping apparatus.

### 2. Related Art

Research and development are carried out on a three-dimensional shaping apparatus that shapes a three-dimensional shaped object by stacking powder layers of a powder containing a metal powder and the like.

Such a three-dimensional shaping apparatus forms a powder layer, discharges a shaping liquid containing a binder to at least a part of the powder layer every time the powder layer is formed, and heats the powder layer to which the shaping liquid has been discharged. The three-dimensional shaping apparatus thus melts the powder in a region to which the shaping liquid has been discharged, of a region of the powder layer, and shapes the three-dimensional shaped object.

In connection with this, a three-dimensional shaping apparatus that includes a shaping head discharging a shaping liquid and a carriage moving the shaping head relatively to the powder layer, and in which a cartridge containing the shaping liquid is installed in the carriage and the shaping head discharges the shaping liquid supplied from the cartridge installed in the carriage to the powder layer, thereby shaping the three-dimensional shaped object, is known, as disclosed in JP-A-2015-217587.

JP-A-2015-217587 is an example of the related art.

In the three-dimensional shaping apparatus as described in JP-A-2015-217587, the three-dimensional shaped object is shaped in a predetermined three-dimensional shaping region. The three-dimensional shaping region is a region close to the carriage. This is because the shaping of the three-dimensional shaped object is performed by discharging the shaping liquid from the shaping head moved by the carriage to the powder layer. Therefore, in the three-dimensional shaping apparatus, the user may interfere with the cartridge installed in the carriage when taking out the three-dimensional shaped object from the three-dimensional shaping region. In order to solve such a problem, there is a method in which a position where the user does not interfere with the cartridge when taking out the three-dimensional shaped object from the three-dimensional shaping region is set to be the home position of the carriage. However, when the position is set to be the home position, the user finds it hard to replace the cartridge. This, too, leads to a reduction in user convenience, which is not desirable.

In view of the above circumstances, the three-dimensional shaping apparatus may be provided with a shaping liquid storage unit that stores a shaping liquid to a casing, instead of the cartridge. In this case, a supply pipe coupling the shaping liquid storage unit and the shaping head is often housed in a wiring cover together with a flexible cable coupling the shaping head and the connector of the casing. However, the flexible cable bends with the movement of the shaping head by the carriage. Therefore, the flow path cross-sectional area of the supply pipe laid together with the flexible cable may decrease with the movement of the shaping head, and consequently, a supply failure of the shaping liquid from the shaping liquid storage unit to the shaping head may occur.

### SUMMARY

According to one aspect of the present disclosure, a three-dimensional shaping apparatus is provided, the apparatus including: a casing having a first connector and a second connector; a shaping stage to which powder is supplied and at which a powder layer is formed; a layer forming unit that forms a powder layer at the shaping stage; a first carriage that moves the layer forming unit relatively to the shaping stage; a shaping head that discharges a liquid containing a binder onto the powder layer formed at the shaping stage; a liquid storage unit that is provided in the casing and stores the liquid; a supply pipe that couples the liquid storage unit and the shaping head; a second carriage moves the shaping head relatively to the shaping stage; a first cable that couples the first connector and the layer forming unit; and a second cable that couples the second connector and the shaping head, wherein the first cable includes a first turn-around portion where a direction in which the first cable extends is turned around, the supply pipe includes a second turn-around portion where a direction in which the supply pipe extends is turned around, and a radius of curvature of the second turn-around portion is larger than a radius of curvature of the first turn-around portion.

### BRIEF DESCRIPTION OF THE DRAWINGS

FIG. 1 is a front view illustrating an example of the configuration of a three-dimensional shaping apparatus.

FIG. 2 is a top view of the three-dimensional shaping apparatus shown in FIG. 1.

FIG. 3 is a top view illustrating an example of the configuration of the three-dimensional shaping apparatus according to Modification Example 1 of the embodiment.

FIG. 4 is a top view illustrating an example of the configuration of the three-dimensional shaping apparatus according to Modification Example 2 of the embodiment.

FIG. 5 is a top view illustrating an example of the configuration of the three-dimensional shaping apparatus according to Modification Example 3 of the embodiment.

FIG. 6 is a front view illustrating an example of the configuration of the three-dimensional shaping apparatus according to Modification Example 4 of the embodiment.

### DESCRIPTION OF EMBODIMENTS

### Embodiment

An embodiment of the present disclosure will now be described with reference to the drawings.

### Overview of Three-Dimensional Shaping Apparatus

First, an overview of a three-dimensional shaping apparatus according to the embodiment will be described.

The three-dimensional shaping apparatus according to the embodiment includes a casing, a shaping stage, a layer forming unit, a first carriage, a shaping head, a liquid storage unit, a supply pipe, a second carriage, a first cable, and a second cable. The casing has a first connector and a second connector. A powder is supplied to the shaping stage and a powder layer is formed there. The layer forming unit forms a powder layer on the shaping stage. The first carriage moves the layer forming unit relatively to the shaping stage. The shaping head discharges a liquid containing a binder to the powder layer formed at the shaping stage. The liquid storage unit is provided in the casing and stores the liquid. The supply pipe couples the liquid storage unit and the shaping head. The second carriage moves the shaping head relatively to the shaping stage. The first cable couples the first connector and the first carriage. The second cable couples the second connector and the shaping head. The supply pipe has a first turn-around portion where the direction in which the supply pipe extends is turned around. The first cable has a second turn-around portion where the direction in which the first cable extends is turned around. The radius of curvature of the first turn-around portion is larger than the radius of curvature of the second turn-around portion. Thus, in the three-dimensional shaping apparatus, the flow path cross-sectional area of the supply pipe can be suppressed from decreasing according to the movement of the shaping head.

Hereinafter, the configuration of the three-dimensional shaping apparatus according to the embodiment will be described in detail.

### Configuration of Three-Dimensional Shaping Apparatus

The configuration of the three-dimensional shaping apparatus according to the embodiment will now be described, taking a three-dimensional shaping apparatus 1 as an example.

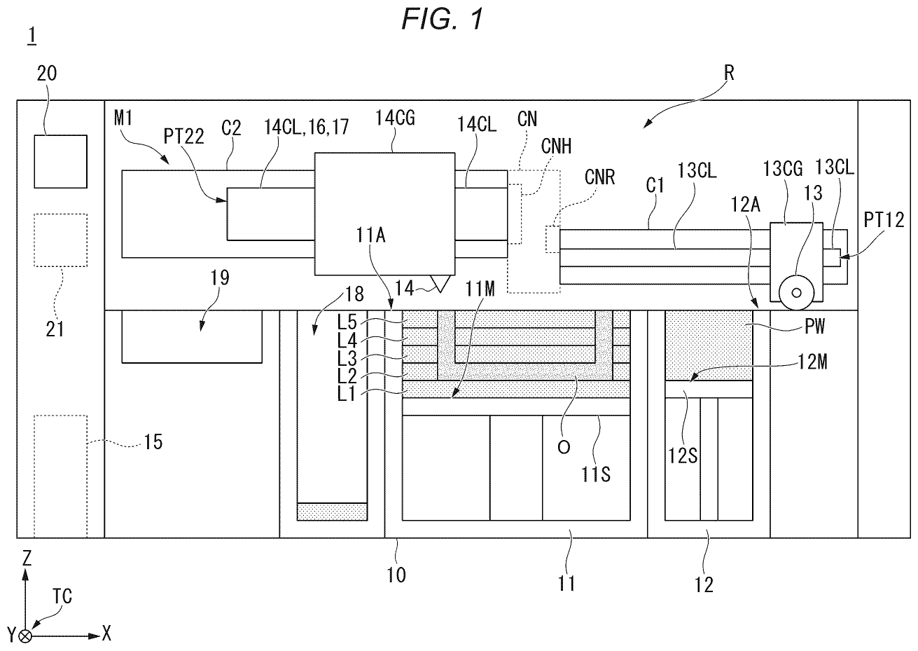

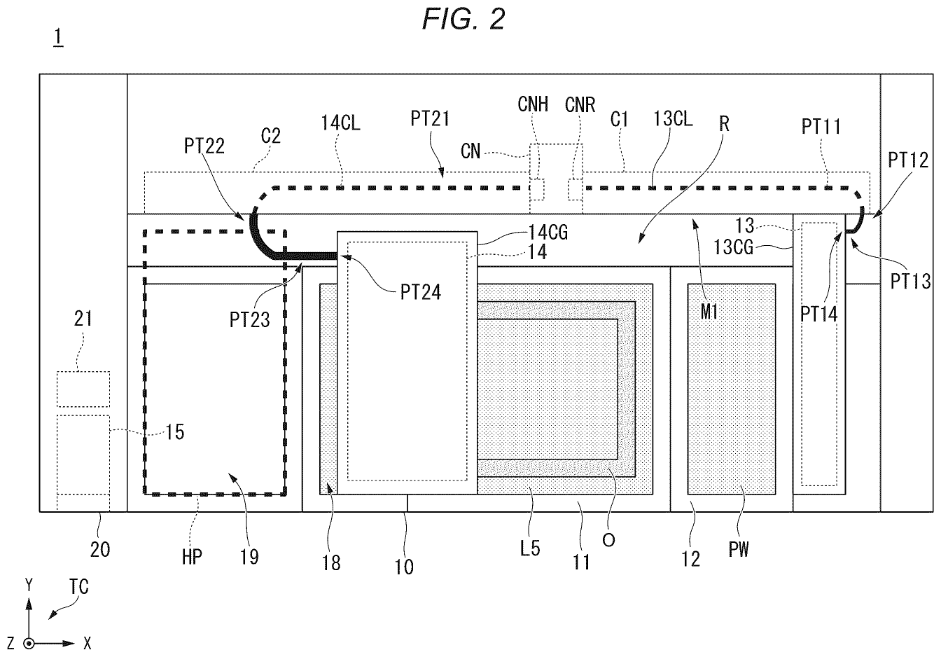

FIG. 1 is a front view illustrating an example of the configuration of the three-dimensional shaping apparatus 1. FIG. 2 is a top view of the three-dimensional shaping apparatus 1 shown in FIG. 1. However, in FIG. 1, in order to clearly show the configuration of the three-dimensional shaping apparatus 1, the illustration is given in such a way that a part of the inside of the three-dimensional shaping apparatus 1 is visible. In FIG. 2, in order to clearly show the configuration of the three-dimensional shaping apparatus 1, a part behind the top plate of the three-dimensional shaping apparatus 1 is illustrated so as to be visible.

A three-dimensional coordinate system TC is a three-dimensional orthogonal coordinate system indicating directions in the drawing in which the three-dimensional coordinate system TC is drawn. In the following description, for convenience of description, an X axis in the three-dimensional coordinate system TC will be simply referred to as an X axis. In the following description, for convenience of description, a Y axis in the three-dimensional coordinate system TC will be simply referred to as a Y axis. In the following description, for convenience of description, a Z axis in the three-dimensional coordinate system TC will be simply referred to as a Z axis. Also, in the following description, for example, a case where a negative direction of the Z axis coincides with the direction of gravity will be described. Therefore, in the following description, for convenience of description, a positive direction of the Z axis will be referred to as upward or simply as up, and the negative direction of the Z axis will be referred to as downward or simply as down. Also, in the following description, a case where the three-dimensional shaping apparatus 1 is viewed in a certain direction will be referred to as a case viewed from the direction.

The three-dimensional shaping apparatus 1 is a device that shapes a three-dimensional shaped object by stacking N powder layers using a powder of a predetermined type of shaping material. N may be any integer equal to or greater than 1. In the following description, for convenience of description, a powder layer that is the n-th from the bottom of the N powder layers stacked by the three-dimensional shaping apparatus 1 will be referred to as an n-th powder layer. n is any integer within a range of 1 or greater and N or smaller. That is, the three-dimensional shaping apparatus 1 forms an n-th powder layer above an (n−1) th powder layer. In this case, a 0th powder layer indicates the shaping surface at which the three-dimensional shaped object is shaped by the three-dimensional shaping apparatus 1.

The shaping material may be, for example, a plant-derived fiber material, a metal, or another material. In the following description, for example, a case where the shaping material is a plant-derived fiber material will be described. The plant-derived fiber material is, for example, a lignocellulosic material. The lignocellulosic material is, for example, a fiber material collected from a bast of a hemp plant such as kenaf, flax, ramie, cannabis, and jute. Also, the lignocellulosic material is, for example, a fiber material collected from a stem or a leaf vein of a hemp plant such as Manila hemp and sisal hemp. Also, the lignocellulosic material is, for example, a wood fiber material using a conifer, a broad-leaved tree, or the like, as a raw material. However, the lignocellulosic material is not limited to these. The plant-derived fiber material may also be other plant-derived fiber materials instead of the lignocellulosic material. In the following description, for example, a case where the plant-derived fiber material is the lignocellulosic material will be described. In the following description, for convenience of description, a powder containing the lignocellulosic material will be referred to as a powder P. The powder P may contain other materials in addition to the lignocellulosic material. In the following description, for example, a case where the powder P contains the lignocellulosic material and does not contain other materials will be described.

The three-dimensional shaping apparatus 1 includes, for example, a casing 10, a shaping stage unit 11, a supply stage unit 12, a layer forming unit 13, a first carriage 13CG, a first cable 13CL, a shaping head 14, a second carriage 14CG, a second cable 14CL, a liquid storage unit 15, a supply pipe 16, a wiring cover 17, a powder recovery unit 18, a maintenance unit 19, a display unit 20, and a control unit 21. The three-dimensional shaping apparatus 1 may be configured without including a part or all of the liquid storage unit 15, the wiring cover 17, the powder recovery unit 18, the maintenance unit 19, the display unit 20, and the control unit 21. The three-dimensional shaping apparatus 1 may be configured, including other members, other devices, and the like, in addition to the casing 10, the shaping stage unit 11, the supply stage unit 12, the layer forming unit 13, the first carriage 13CG, the first cable 13CL, the shaping head 14, the second carriage 14CG, the second cable 14CL, the liquid storage unit 15, the supply pipe 16, the wiring cover 17, the powder recovery unit 18, the maintenance unit 19, the display unit 20, and the control unit 21. The three-dimensional shaping apparatus 1 may be configured, including other members, other devices, or the like, instead of a part or all of the liquid storage unit 15, the wiring cover 17, the powder recovery unit 18, the maintenance unit 19, the display unit 20, and the control unit 21.

The casing 10 is the casing of the three-dimensional shaping apparatus 1. In the example shown in FIGS. 1 and 2, the casing 10 has a substantially rectangular parallelepiped shape as a whole. The upward and downward directions in the casing 10 are predetermined. Hereinafter, as an example, a case where the downward direction in the casing 10 coincides with the direction of gravity will be described. In this case, the upward direction in the casing 10 coincides with the positive direction of the Z axis. The casing 10 may have another shape instead of the substantially rectangular parallelepiped shape as a whole.

The casing 10 has a connector unit CN provided in the casing 10.

The connector unit CN is a member to which each of the first cable 13CL and the second cable 14CL is coupled in the three-dimensional shaping apparatus 1. The connector unit CN includes a first connector CNR and a second connector CNH.

The first connector CNR is a connector to which the first cable 13CL is coupled. The first connector CNR is also coupled to a cable coupling the first connector CNR and the control unit 21. Therefore, the first connector CNR relays communication and power supply via the first cable 13CL between the control unit 21 and the layer forming unit 13. In FIGS. 1 and 2, in order to prevent the complexity of the drawings, the cable coupling the first connector CNR and the control unit 21 is omitted.

The second connector CNH is a connector to which the second cable 14CL is coupled. The second connector CNH is also coupled to a cable coupling the second connector CNH and the control unit 21. Therefore, the second connector CNH relays communication and power supply via the second cable 14CL between the control unit 21 and the shaping head 14. In FIGS. 1 and 2, in order to prevent the complexity of the drawings, the cable coupling the second connector CNH and the control unit 21 is omitted.

A three-dimensional shaping region R where the three-dimensional shaping apparatus 1 shapes a three-dimensional shaped object is formed in the casing 10. The three-dimensional shaping region R is also a region where the three-dimensional shaped object is taken out by the user, the powder P is supplied by the user, and various kinds of maintenance and the like are performed by the user, in addition to the shaping of the three-dimensional shaped object by the three-dimensional shaping apparatus 1. Therefore, the casing 10 is open in a predetermined direction. In the example shown in FIGS. 1 and 2, the casing 10 is open in the negative direction of the Y axis. Therefore, the user can put a hand into the three-dimensional shaping region R from the opening of the casing 10 into the positive direction of the Y axis and perform various operations. In this example, the three-dimensional shaping region is a R substantially rectangular parallelepiped region as a whole. The three-dimensional shaping region R may have another shape. The opening of the casing 10 may be configured to be able to be opened and closed by a cover or may be constantly open. When the opening of the casing 10 is configured to be able to be opened and closed by the cover, the cover may be either transparent or opaque.

The casing 10 has a first surface M1 as a surface in contact with the three-dimensional shaping region R. In the example illustrated in FIGS. 1 and 2, the first surface M1 is a surface parallel to the direction of gravity, and is a surface that is seen behind the three-dimensional shaping region R when the three-dimensional shaping region R is viewed in the positive direction of the Y axis. The first surface M1 may be a surface that is not parallel to the direction of gravity.

A first groove C1 and a second groove C2 are formed in the first surface M1.

The first groove C1 is a groove extending parallel to the X axis and is a groove for guiding the movement of the first cable 13CL described later. Therefore, a part of the first cable 13CL is laid along the first groove C1. In FIGS. 1 and 2, in order to facilitate distinction between the first groove C1 and the first cable 13CL, the width of the first groove C1 in the direction of gravity is drawn to be greater than the width of the first cable 13CL in the direction of gravity to a greater degree than in reality. In reality, the width of the first groove C1 in the direction of gravity is slightly greater than the width of the first cable 13CL in the direction of gravity. This is because the first groove C1 is provided to guide the first cable 13CL.

The second groove C2 is a groove extending parallel to the X axis and is a groove for guiding the movement of the second cable 14CL described later. Therefore, a part of the second cable 14CL is laid along the second groove C2. In FIGS. 1 and 2, in order to facilitate distinction between the second groove C2 and the second cable 14CL, the width of the second groove C2 in the direction of gravity is drawn to be greater than the actual width of the second cable 14CL in the direction of gravity to a greater degree than in reality. In reality, the width of the second groove C2 in the direction of gravity is slightly greater than the width of the second cable 14CL in the direction of gravity. This is because the second groove C2 is provided to guide the second cable 14CL.

In the example shown in FIGS. 1 and 2, the connector unit CN is sandwiched between the first groove C1 and the second groove C2. Therefore, the first groove C1 extends in the positive direction of the X axis from the connector unit CN. The second groove C2 extends in the negative direction of the X axis from the connector unit CN. The connector unit CN may be provided behind the first surface M1 or in front of the first surface M1 when viewed from the positive direction of the Y axis, or may be provided in another method. Hereinafter, as shown in FIGS. 1 and 2, a case where the connector unit CN is provided behind the first surface M1 in the above case will be described.

The shaping stage unit 11 is one of the devices provided in the casing 10. The shaping stage unit 11 is controlled by the control unit 21. The shaping stage unit 11 includes a shaping stage 11S.

The shaping stage 11S is a member having a shaping surface 11M. The shaping surface 11M is a surface where a three-dimensional shaped object is shaped in the three-dimensional shaping apparatus 1, and is an example of the above-described shaping surface. That is, the shaping surface 11M is a surface where the above-described N powder layers are stacked, of the surfaces of the shaping stage 11S.

The shaping stage unit 11 moves the shaping stage 11S up and down relatively to an upper surface 11A of the shaping stage unit 11 under the control of the control unit 21. Therefore, the shaping surface 11M moves up and down relatively to the upper surface 11A as the shaping stage 11S moves up and down. That is, the shaping surface 11M moves upward relatively to the upper surface 11A as the shaping stage 11S moves upward. The shaping surface 11M moves downward relatively to the upper surface 11A as the shaping stage 11S moves downward. The shaping stage unit 11 includes an actuator and the like as various members that move the shaping stage 11S up and down. However, in FIGS. 1 and 2, the various members are omitted to prevent the complexity of the drawings.

More specifically, when the three-dimensional shaping apparatus 1 is to form a first powder layer on the shaping surface 11M, the shaping stage unit 11 moves the shaping stage 11S in such a way that the shaping surface 11M is located below the upper surface 11A of the shaping stage unit 11 by the thickness of the first powder layer, in response to a request from the control unit 21. Thus, the three-dimensional shaping apparatus 1 forms the first powder layer on the shaping surface 11M by the layer forming unit 13, described later. Also, when the three-dimensional shaping apparatus 1 is to form the n-th powder layer on the (n−1) th powder layer, the shaping stage unit 11 moves the shaping stage 11S in such a way that the upper surface of the (n−1) th powder layer is located below the upper surface 11A by the thickness of the n-th powder layer, in response to a request from the control unit 21. The thickness of the n-th powder layer is the thickness of the n-th powder layer in the direction of gravity.

Five powder layers, that is, powder layers L1 to L5, are stacked on the shaping surface 11M illustrated in FIG. 1. The powder layer L1 is an example of the first powder layer. The powder layer L2 is an example of a second powder layer. The powder layer L3 is an example of a third powder layer. The powder layer L4 is an example of a fourth powder layer. The powder layer L5 is an example of a fifth powder layer.

The supply stage unit 12 is one of the devices provided in the casing 10. The supply stage unit 12 is controlled by the control unit 21. The supply stage unit 12 includes a supply stage 12S.

The supply stage 12S is a member having a holding surface 12M. The holding surface 12M is a surface where the powder P before being supplied to the shaping stage unit 11 is held in the three-dimensional shaping apparatus 1. That is, the holding surface 12M is a surface where the powder P before being supplied to the shaping stage unit 11 is replenished by the user, of the surfaces of the supply stage 12S.

The supply stage unit 12 moves the supply stage 12S up and down relatively to an upper surface 12A of the supply stage unit 12 under the control of the control unit 21. The upper surface 12A is a surface provided on an imaginary plane including the upper surface 11A. In other words, the upper surface 12A is a surface parallel to the upper surface 11A and has the same surface as the height of the upper surface 11A. Therefore, the holding surface 12M moves up and down relatively to the upper surface 12A as the supply stage 12S moves up and down. That is, the holding surface 12M moves upward relatively to the upper surface 12A as the supply stage 12S moves upward. The holding surface 12M moves downward relatively to the upper surface 12A as the supply stage 12S moves downward. The supply stage unit 12 includes an actuator and the like as various members that move the supply stage 12S up and down. However, in FIGS. 1 and 2, the various members are omitted to prevent the complexity of the drawings.

More specifically, when the three-dimensional shaping apparatus 1 is to form a powder layer on the shaping surface 11M, the supply stage unit 12 moves the supply stage 12S in such a way as to lift up the powder P having the same volume as the volume of the powder layer above the upper surface 12A of the supply stage unit 12, in response to a request from the control unit 21. Thus, the three-dimensional shaping apparatus 1 moves the powder P onto the shaping surface 11M by the layer forming unit 13, described later, and forms the powder layer on the shaping surface 11M. In FIG. 1, the powder held on the holding surface 12M is indicated by a powder PW.

In the example illustrated in FIGS. 1 and 2, the shaping stage unit 11 and the supply stage unit 12 are arranged in the order of the shaping stage unit 11 and the supply stage unit 12 in the positive direction of the X axis. Therefore, the powder P lifted up by the supply stage 12S is moved in the negative direction of the X axis by the layer forming unit 13 and is formed into the powder layer on the shaping surface 11M. The shaping stage unit 11 and the supply stage unit 12 may be arranged in the order of the shaping stage unit 11 and the supply stage unit 12 in another direction.

The layer forming unit 13 is one of the devices provided in the casing 10. The layer forming unit 13 moves the powder P held on the holding surface 12M of the supply stage 12S toward the shaping stage 11S and presses and levels the powder P after the movement, and thus forms a powder layer on the shaping surface 11M of the shaping stage 11S. The layer forming unit 13 repeats the formation of such a powder layer N times and stacks N powder layers on the shaping surface 11M. The shaping surface 11M of the shaping stage 11S may be rephrased as the shaping stage 11S. The layer forming unit 13 includes a member configured to be able to move the powder P held on the holding surface 12M of the supply stage 12S toward the shaping stage 11S and press and level the powder P moved by this movement onto the shaping surface of the shaping stage 11S, as a powder layer. In the example shown in FIGS. 1 and 2, the member is a roller. The member may be, for example, a squeegee or the like instead of a roller. The layer forming unit 13 includes a motor or the like as various members for rotating the roller as the member. However, in FIGS. 1 and 2, the various members are omitted to prevent the complexity of the drawings.

In the example shown in FIGS. 1 and 2, the layer forming unit 13 includes a roller that rotates about a rotation axis extending in the positive direction of the Y axis. As described above, in this example, the shaping stage unit 11 and the supply stage unit 12 are arranged in the order of the shaping stage unit 11 and the supply stage unit 12 in the positive direction of the X axis. Therefore, in this example, the layer forming unit 13 moves in the negative direction of the X axis by the first carriage 13CG, described later, and moves the powder P held on the holding surface 12M of the supply stage 12S. Thus, the layer forming unit 13 can move the powder P toward the shaping stage 11S and press and level the powder P moved by this movement onto the shaping surface of the shaping stage 11S, as a powder layer. In the description below, for convenience of description, the negative direction of the X axis will be referred to as a first direction. In the description below, for convenience of description, the positive direction of the X axis will be referred to as a second direction.

The first cable 13CL is coupled to the layer forming unit 13. Thus, the layer forming unit 13 rotates the roller under the control of and with the power supply from the control unit 21 via the first cable 13CL.

In addition, the layer forming unit 13 is moved by the first carriage 13CG in such a way that the layer forming unit 13 is located at a layer forming unit waiting position predetermined as a position where the layer forming unit 13 waits in a state where the three-dimensional shaping apparatus 1 is not executing the shaping of a three-dimensional shaped object. The layer forming unit waiting position may be referred to as a home position of the layer forming unit 13. The position where the layer forming unit 13 is located in FIGS. 1 and 2 is an example of the layer forming unit waiting position. That is, in the example shown in FIGS. 1 and 2, the layer forming unit waiting position is located next to the supply stage 12S in the second direction when viewed from the direction of gravity. In other words, when viewed from the direction of gravity, the shaping stage 11S, the supply stage 12S, and the layer forming unit waiting position are arranged in the order of the shaping stage 11S, the supply stage 12S, and the layer forming unit waiting position in the second direction.

The first carriage 13CG is one of the devices provided in the casing 10. The first carriage 13CG moves the layer forming unit 13 relatively to the shaping stage 11S. Specifically, the first carriage 13CG moves the layer forming unit 13 forward and backward in the first direction. The first carriage 13CG includes an actuator and the like as various members that move the first carriage 13CG forward and backward in the first direction. However, in FIGS. 1 and 2, the various members are omitted to prevent the complexity of the drawings.

The first cable 13CL is a cable that couples the first connector CNR and the layer forming unit 13. Specifically, the first cable 13CL is a flexible cable.

The shaping head 14 is one of the devices provided in the casing 10. The shaping head 14 is a device that discharges a liquid containing a binder as a shaping liquid. The shaping head 14 is, for example, a printer head. The shaping head 14 may be a printer head in which the amount of the shaping liquid discharged per unit time is adjustable, or may be a printer head in which the amount of the shaping liquid discharged per unit time is not adjustable. The shaping head 14 may be another device configured to be able to discharge the shaping liquid instead of the printer head. The shaping head 14 includes a plurality of nozzles, not illustrated, which are arranged in a direction orthogonal to the first direction and the direction of gravity. In response to a request from the control unit 21, the shaping head 14 discharges the shaping liquid supplied from the liquid storage unit 15 storing the shaping liquid, downward from one or more nozzles designated by the control unit 21 from among the plurality of nozzles. Thus, the shaping head 14 can discharge the shaping liquid to at least a part of a predetermined shaping region for each powder layer.

The powder layer includes a shaping region forming at least a part of a three-dimensional shaped object, and a non-shaping region, which does not form a part of the three-dimensional shaped object. The predetermined shaping region in a certain powder layer includes an outline region forming an outline, and an infill region forming an infill. The outline refers to the powder P forming the contour of the three-dimensional shaped object, of the powder P contained in the powder layer. That is, the outline region is a region filled with the powder P forming the contour of the three-dimensional shaped object, of the powder P contained in the powder layer. The infill refers to the powder P forming the inside of the three-dimensional shaped object, of the powder P contained in the powder layer. That is, the infill region is a region filled with the powder P forming the inside of the three-dimensional shaped object, of the powder P contained in the powder layer.

The binder contained in the shaping liquid may be any binder that can bind together individual particles contained in the powder P of the powder layer by melting. Examples of the binder contained in the shaping liquid include, but are not limited to, acrylonitrile-butadiene-styrene (ABS), acrylonitrile-styrene-acrylate (ASA), polyethylene (PE), paraffin wax, and the like. In the following description, for example, a case where the binder is paraffin wax will be described.

A liquid serving as a solvent or a dispersion medium of the binder in the shaping liquid as described above may be any liquid that can dissolve or disperse the binder and that vaporizes at a temperature lower than the melting point of the binder. More preferably, the liquid serving as the solvent or the dispersion medium of the binder in the shaping liquid is a liquid that vaporizes at about room temperature in a room where the three-dimensional shaping apparatus 1 is provided. The room temperature is, for example, about 20° C. to 30° C. but is not limited thereto.

The second cable 14CL is coupled to the shaping head 14. Thus, the shaping head 14 discharges the shaping liquid under the control of and with the power supply from the control unit 21 via the second cable 14CL.

For example, when moved in the second direction by the second carriage 14CG, described later, under the control of the control unit 21, the shaping head 14 discharges the shaping liquid to at least the outline region of the shaping region of the powder layer. Thus, the shaping head 14 shapes the three-dimensional shaped object. The region where the shaping liquid is discharged from the shaping head 14, of the regions provided in the stacked N powder layers, is a region to be the three-dimensional shaped object. A region O illustrated in FIGS. 1 and 2 is an example of the region where the shaping liquid is discharged from the shaping head 14, of the regions provided in the above-described powder layers L1 to L5. The shaping head 14 may be configured to discharge the shaping liquid to at least the outline region of the shaping region of the powder layer, when moved in the first direction by the second carriage 14CG.

In addition, the shaping head 14 is moved by the second carriage 14CG in such a way that the shaping head 14 is located at a shaping head waiting position predetermined as a position where the shaping head 14 waits in a state where the three-dimensional shaping apparatus 1 is not executing the shaping of the three-dimensional shaped object. The shaping head waiting position may be referred to as a home position of the shaping head 14. In FIG. 2, the shaping head waiting position is shown as a region surrounded by a dotted line HP. That is, in the example illustrated in FIGS. 1 and 2, the shaping head waiting position is located next to the shaping stage 11S in the first direction when viewed from the direction of gravity. In other words, when viewed from the direction of gravity, the shaping stage 11S, the supply stage 12S, and the shaping head waiting position are arranged in the order of the shaping head waiting position, the shaping stage 11S, and the supply stage 12S in the second direction. In other words, in this example, the shaping head waiting position and the layer forming unit waiting position are arranged at the opposite sides across both the shaping stage 11S and the supply stage 12S when viewed from the direction of gravity. Thus, in the three-dimensional shaping apparatus 1, the distance between the shaping head 14 and the layer forming unit 13 can be made longer and the nozzles of the shaping head 14 can thus be suppressed from being clogged with the powder P flying up in the air.

The second carriage 14CG is one of the devices arranged in the casing 10. The second carriage 14CG moves the shaping head 14 relatively to the shaping stage 11S. Specifically, the second carriage 14CG moves the shaping head 14 forward and backward in the second direction. The second carriage 14CG includes an actuator and the like as various members that move the second carriage 14CG forward and backward in the second direction. However, in FIGS. 1 and 2, the various members are omitted to prevent the complexity of the drawings.

The second cable 14CL is a cable that couples the second connector CNH and the shaping head 14. Specifically, the second cable 14CL is a flexible cable.

The liquid storage unit 15 is a member provided in the casing 10. The liquid storage unit 15 is configured, including a container that stores the shaping liquid. The container of the liquid storage unit 15 stores the shaping liquid supplied by the user. The liquid storage unit 15 supplies the shaping liquid from the container to the shaping head 14 via the supply pipe 16, described later. The liquid storage unit 15 includes, in addition to the container, a pump or the like as various members that supply the shaping liquid to the shaping head 14 via the supply pipe 16. However, in FIGS. 1 and 2, the various members are omitted to prevent the complexity of the drawings. The liquid storage unit 15 may be provided in the casing 10 or outside the casing 10. When the liquid storage unit 15 is provided outside the casing 10, the user can replenish the shaping liquid to the liquid storage unit 15 more easily than when the liquid storage unit 15 is provided in the casing 10.

The supply pipe 16 is a pipe that couples the liquid storage unit 15 and the shaping head 14 and supplies the shaping liquid from the liquid storage unit 15 to the shaping head 14. Specifically, the supply pipe 16 is a flexible pipe.

The wiring cover 17 is a wiring cover that accommodates the second cable 14CL and the supply pipe 16. Since the three-dimensional shaping apparatus 1 includes the wiring cover 17, the supply pipe 16 bends together with the second cable 14CL in accordance with the movement of the shaping head 14. In FIGS. 1 and 2, in order to simplify the drawings, the second cable 14CL and the supply pipe 16 are illustrated as not being separated at either end of the wiring cover 17. However, the second cable 14CL and the supply pipe 16 may be separated toward the respective coupling points, at both ends of the wiring cover 17.

The powder recovery unit 18 is a member that collects the remaining powder P that has not formed a powder layer, of the powder P used to form the powder layer by the layer forming unit 13. The powder recovery unit 18 is, for example, a container having a recessed portion that stores the remaining powder P. In the example illustrated in FIGS. 1 and 2, the powder recovery unit 18 is located next to the shaping stage unit 11 in the first direction. In other words, the shaping head waiting position and the shaping stage 11S are arranged at the opposite sides of the powder recovery unit 18. Thus, in the three-dimensional shaping apparatus 1, the distance between the shaping head 14 and the layer forming unit 13 can be made longer more securely and consequently the nozzles of the shaping head 14 can be more securely suppressed from being clogged with the powder P flying up in the air. The powder recovery unit 18 is open upward. The upper surface of the powder recovery unit 18 is provided on an imaginary plane including the upper surface 11A of the shaping stage unit 11. Therefore, the remaining powder P pushed and moved in the first direction by the layer forming unit 13 falls into the recessed portion of the powder recovery unit 18 with the movement of the layer forming unit 13 in the first direction. Thus, the powder recovery unit 18 can collect the remaining powder P.

The maintenance unit 19 is one of the devices provided in the casing 10. The maintenance unit 19 is located next to the powder recovery unit 18 in the first direction. The maintenance unit 19 is provided below the shaping head waiting position. The maintenance unit 19 includes a recessed portion that is open upward, and is configured including a device that performs cleaning or the like of the nozzles of the shaping head 14, in the recessed portion. In FIGS. 1 and 2, the device is omitted in order to prevent the complexity of the drawings.

The display unit 20 is a display device including a display that displays various images in response to a request from the control unit 21.

The control unit 21 controls the entirety of the three-dimensional shaping apparatus 1. The control unit 21 causes the three-dimensional shaping apparatus 1 to operate in response to an operation from the user via an operation panel, not illustrated, that is provided in the three-dimensional shaping apparatus 1, an information processing device communicably coupled to the three-dimensional shaping apparatus 1, or the like. The control unit 21 includes a processor such as a central processing unit (CPU) or a field-programmable gate array (FPGA), and a storage unit such as a memory.

As shown in FIG. 2, the first cable 13CL has a second-direction extension portion PT11 extending in the second direction from the first connector CNR, a first turn-around portion PT12 where the direction in which the first cable 13CL extends is turned around, and a first-direction extension portion PT13 extending in the first direction from the first turn-around portion PT12. However, in the first turn-around portion PT12, the first cable 13CL is turned around about an imaginary axis parallel or substantially parallel to the direction of gravity. The end portion of the first-direction extension portion PT13 is coupled to the layer forming unit 13. The position of the first turn-around portion PT12 on the first cable 13CL changes according to the movement of the first carriage 13CG. Therefore, the length of each of the second-direction extension portion PT11 and the first-direction extension portion PT13 changes according to the movement of the layer forming unit 13 by the first carriage 13CG. The second-direction extension portion PT11 is also a portion laid along the first groove C1, of the portions of the first cable 13CL.

In the three-dimensional shaping apparatus 1, an increase in the length of the first cable 13CL leads to an increase in the manufacturing cost. Therefore, it is more desirable that the first cable 13CL is shorter. For such reasons, it is more desirable that the radius of curvature of the first turn-around portion PT12 is smaller. This is because the length of the first cable 13CL becomes longer as the radius of curvature of the first turn-around portion PT12 becomes greater. However, a minimum bending radius to prevent a break in the first cable 13CL is predetermined for the first cable 13CL. Therefore, the radius of curvature of the first turn-around portion PT12 must be equal to or greater than the minimum bending radius of the first cable 13CL. Thus, in the description below, as an example, a case where the radius of curvature of the first turn-around portion PT12 coincides with the minimum bending radius of the first cable 13CL will be described.

Meanwhile, as described above, the second cable 14CL is accommodated in the wiring cover 17 together with the supply pipe 16. This is to prevent the second cable 14CL and the supply pipe 16 from moving separately. When the second cable 14CL and the supply pipe 16 move separately, the second cable 14CL and the supply pipe 16 may interfere with each other according to the movement of the shaping head 14 by the second carriage 14CG. This may cause a break in the cable and therefore is not desirable. In view of such circumstances, in the three-dimensional shaping apparatus 1, the second cable 14CL is accommodated in the wiring cover 17 together with the supply pipe 16. Therefore, as shown in FIG. 2, the second cable 14CL and the supply pipe 16 have a first-direction extension portion PT21 extending in the first direction from the second connector CNH, a second turn-around portion PT22 where the direction in which the second cable 14CL extends is turned around, and a second-direction extension portion PT23 extending in the second direction from the second turn-around portion PT22. However, in the second turn-around portion PT22, the second cable 14CL and the supply pipe 16 are turned around about an imaginary axis parallel or substantially parallel to the direction of gravity. The end portion of the second-direction extension portion PT23 is coupled to the shaping head 14. The position of the second turn-around portion PT22 on the second cable 14CL and the supply pipe 16 changes according to the movement of the second carriage 14CG. Therefore, the length of each of the first-direction extension portion PT21 and the second-direction extension portion PT23 changes according to the movement of the shaping head 14 by the second carriage 14CG. The first-direction extension portion PT21 is also a portion laid along the second groove C2, of the portions of each of the second cable 14CL and the supply pipe 16.

In the three-dimensional shaping apparatus 1, an increase in the length of the second cable 14CL leads to an increase in the manufacturing cost is increased. Therefore, it is more desirable that the second cable 14CL is shorter. For such reasons, it is desirable that the radius of curvature of the second turn-around portion PT22 is smaller. However, when the radius of curvature is too small, the flow path cross-sectional area of the supply pipe 16 decreases, too. This may cause supply failure of the shaping liquid to the shaping head 14 via the supply pipe 16 and is therefore not desirable.

Such a problem does not occur when the liquid storage unit 15 is provided in the second carriage 14CG as a cartridge that supplies the shaping liquid. This is because, in this case, the supply pipe coupling the liquid storage unit 15 and the shaping head 14 and supplying the shaping liquid stored in the liquid storage unit 15 to the shaping head 14 does not bend according to the movement of the shaping head 14. That is, it can be said that the problem in that the flow path cross-sectional area of the supply pipe 16 decreases according to the movement of the shaping head 14 is a problem unique to the three-dimensional shaping apparatus 1 having the liquid storage unit 15 provided in the casing 10.

In order to solve the problem in that the flow path cross-sectional area of the supply pipe 16 decreases according to the movement of the shaping head 14, in the three-dimensional shaping apparatus 1, the radius of curvature of the second turn-around portion PT22 of the second cable 14CL and the supply pipe 16 is greater than the radius of curvature of the first turn-around portion PT12 of the first cable 13CL. Thus, in the three-dimensional shaping apparatus 1, the flow path cross-sectional area of the supply pipe 16 can be suppressed from decreasing according to the movement of the shaping head 14, as compared with when the radius of curvature of the second turn-around portion PT22 of the second cable 14CL and the supply pipe 16 coincides with the radius of curvature of the first turn-around portion PT12 of the first cable 13CL. Also, in the three-dimensional shaping apparatus 1, the flow path cross-sectional area of the supply pipe 16 can be more securely suppressed from decreasing according to the movement of the shaping head 14 as the difference between the radius of curvature of the second turn-around portion PT22 of the second cable 14CL and the supply pipe 16 and the radius of curvature of the first turn-around portion PT12 of the first cable 13CL is increased. In view of such circumstances, in the three-dimensional shaping apparatus 1, it is difficult to provide a motivation to set the minimum bending radius of the second cable 14CL to be less than the minimum bending radius of the first cable 13CL. Therefore, in the three-dimensional shaping apparatus 1, the minimum bending radius of the second cable 14CL is equal to or greater than the minimum bending radius of the first cable 13CL, unless there is any other reason to set the minimum bending radius of the second cable 14CL to be less than the minimum bending radius of the first cable 13CL.

Also, in the three-dimensional shaping apparatus 1, since the liquid storage unit 15 is provided in the casing 10, the flow path cross-sectional area of the supply pipe 16 can be suppressed from decreasing according to the movement of the shaping head 14, and the amount of the shaping liquid contained in the liquid storage unit 15 can be increased as well. This is because the capacity of the container provided in the liquid storage unit 15 is easily increased as compared with when the liquid storage unit 15 is provided in the second carriage 14CG arranged in the three-dimensional shaping region. Also, in the three-dimensional shaping apparatus 1, since the liquid storage unit 15 is provided in the casing 10, the user can easily take out the three-dimensional shaped object and the convenience for the user can thus be improved. This is because the region occupied by the second carriage 14CG in the three-dimensional shaping region is small since the liquid storage unit 15 is not provided in the second carriage 14CG.

Based on the above, in the three-dimensional shaping apparatus 1, the amount of the shaping liquid stored in the liquid storage unit 15 can be increased, the user can easily take out the three-dimensional shaped object, and the flow path cross-sectional area of the supply pipe 16 can be suppressed from decreasing according to the movement of the shaping head 14.

In the three-dimensional shaping apparatus 1, unnecessarily increasing the length of the second cable 14CL leads to an increase in the manufacturing cost and is therefore not desirable. Therefore, as the radius of curvature of the second turn-around portion PT22 of the second cable 14CL and the supply pipe 16, for example, the minimum radius of curvature, of radii of curvature that are larger than the radius of curvature of the first turn-around portion PT12 of the first cable 13CL and that do not cause a decrease in the flow path cross-sectional area of the supply pipe 16, is selected, based on a prior experiment, simulation, or the like. Thus, in the three-dimensional shaping apparatus 1, an increase in the manufacturing cost can be suppressed and a decrease in the flow path cross-sectional area of the supply pipe 16 according to the movement of the shaping head 14 can be suppressed. Selecting the minimum radius of curvature, of the radii of curvature that do not cause a decrease in the flow path cross-sectional area of the supply pipe 16, leads to the suppression of a noise from disturbing the control of the shaping head 14 via the second cable 14CL and is therefore useful.

In the three-dimensional shaping apparatus 1, in order to make the radius of curvature of the second turn-around portion PT22 larger than the radius of curvature of the first turn-around portion PT12, the shortest distance between a second coupling position PT24 where the second cable 14CL and the shaping head 14 are coupled together, and the first surface M1, is made longer than the shortest distance between a first coupling position PT14 where the first cable 13CL and the layer forming unit 13 are coupled together, and the first surface M1. In the example illustrated in FIGS. 1 and 2, the shortest distance between the second coupling position PT24 where the second cable 14CL and the shaping head 14 are coupled together, and the first surface M1, is a distance in the positive direction of the Y axis, of the distance between the second coupling position PT24 and the first surface M1. In this example, the shortest distance between the first coupling position PT14 where the first cable 13CL and the layer forming unit 13 are coupled together, and the first surface M1, is a distance in the positive direction of the Y axis, of the distance between the first cable 13CL and the layer forming unit 13. Thus, in the three-dimensional shaping apparatus 1, the radius of curvature of the second turn-around portion PT22 of the second cable 14CL can be more securely made greater than the radius of curvature of the first turn-around portion PT12 of the first cable 13CL. That is, in the three-dimensional shaping apparatus 1, the flow path cross-sectional area of the supply pipe 16 can be more securely suppressed from decreasing according to the movement of the shaping head 14.

As illustrated in FIGS. 1 and 2, in the three-dimensional shaping apparatus 1, each of the first cable 13CL and the second cable 14CL does not overlap the shaping surface 11M, when viewed from the direction of gravity. Thus, in three-dimensional shaping apparatus 1, each of the first cable 13CL and the second cable 14CL can be suppressed from interfering with the user and the three-dimensional shaped object that is taken out, when the user takes out the three-dimensional shaped object.

As illustrated in FIGS. 1 and 2, in the three-dimensional shaping apparatus 1, the second turn-around portion PT22, the first carriage 13CG, and the second carriage 14CG are arranged in the order of the second turn-around portion PT22, the second carriage 14CG, and the first carriage 13CG when viewed from a direction orthogonal to the second direction, in which the second carriage 14CG moves to discharge the shaping liquid. Thus, in the three-dimensional shaping apparatus 1, the radius of curvature of the second turn-around portion PT22 of the supply pipe 16 can be suppressed from decreasing. As a result, in the three-dimensional shaping apparatus 1, the flow path cross-sectional area of the supply pipe 16 can be more securely suppressed from decreasing according to the movement of the shaping head 14.

In the three-dimensional shaping apparatus 1 described above, the first cable 13CL may have one or more turn-around portions where the direction in which the first cable 13CL extends is turned around, in addition to the first turn-around portion PT12. That is, the direction in which the first cable 13CL extends may be turned around at two or more positions. However, in this case, in the three-dimensional shaping apparatus 1, the turn-around portion having the smallest radius of curvature, of the one or more turn-around portions of the first cable 13CL, is employed as the first turn-around portion PT12. Thus, in this case, too, in the three-dimensional shaping apparatus 1, the flow path cross-sectional area of the supply pipe 16 can be suppressed from decreasing according to the movement of the shaping head 14.

In the three-dimensional shaping apparatus 1 described above, the second cable 14CL and the supply pipe 16 may have one or more turn-around portions where the direction in which the second cable 14CL and the supply pipe 16 extend is turned around, in addition to the second turn-around portion PT22. That is, the direction in which the second cable 14CL and the supply pipe 16 extend may be turned around at two or more positions. However, in this case, in the three-dimensional shaping apparatus 1, the turn-around portion having the smallest radius of curvature, of the one or more turn-around portions of the second cable 14CL and the supply pipe 16, is employed as the second turn-around portion PT22. Thus, in this case, too, in the three-dimensional shaping apparatus 1, the flow path cross-sectional area of the supply pipe 16 can be suppressed from decreasing according to the movement of the shaping head 14.

In the three-dimensional shaping apparatus 1 described above, the connector unit CN may be divided into a member including the first connector CNR and a member including the second connector CNH. For example, in the three-dimensional shaping apparatus 1, the member including the first connector CNR may be provided in a plate-shaped member forming the side surface of the casing 10 in the second direction, and the member including the second connector CNH may be provided in a plate-shaped member forming the side surface of the casing 10 in the first direction. In this case, in the three-dimensional shaping apparatus 1, the first cable 13CL and the second cable 14CL extend in such a way as to pass by each other, when viewed from the direction of gravity. When viewed from the direction of gravity, the first-direction extension portion PT21 and a first-direction extension portion PT31 may or may not overlap each other. When the first cable 13CL and the second cable 14CL extend in such a way as to pass by each other and the first-direction extension portion PT21 and the first-direction extension portion PT31 overlap each other as viewed from the direction of gravity, the three-dimensional shaping apparatus 1 can easily perform assembly at the time of three-dimensional manufacture.

As described above, the three-dimensional shaping apparatus 1 includes: the casing 10 having the first connector CNR and the second connector CNH; the shaping stage 11S, to which the powder P is supplied and at which the powder layer is formed; the layer forming unit 13, which forms the powder layer at the shaping stage 11S; the first carriage 13CG, which moves the layer forming unit 13 relatively to the shaping stage 11S; the shaping head 14, which discharges the shaping liquid containing the binder to the powder layer formed at the shaping stage 11S; the liquid storage unit 15, which is provided in the casing 10 and stores the shaping liquid; the supply pipe 16 coupling the liquid storage unit 15 and the shaping head 14; the second carriage 14CG, which moves the shaping head 14 relatively to the shaping stage 11S; the first cable 13CL coupling the first connector CNR and the layer forming unit 13; and the second cable 14CL coupling the second connector CNH and the shaping head 14, wherein the first cable 13CL has the first turn-around portion PT12 where the direction in which the first cable 13CL extends is turned around, the supply pipe 16 includes the second turn-around portion PT22 where the direction in which the supply pipe 16 extends is turned around, and the radius of curvature of the second turn-around portion PT22 is greater than the radius of curvature of the first turn-around portion PT12. Thus, in the three-dimensional shaping apparatus 1, the flow path cross-sectional area of the supply pipe 16 can be suppressed from decreasing according to the movement of the shaping head 14.

The three-dimensional shaping apparatus 1 may employ a configuration where the second turn-around portion PT22 of the supply pipe 16, the first carriage 13CG, and the second carriage 14CG are arranged in the order of the turn-around portion, the second carriage 14CG, and the first carriage 13CG when viewed from a direction orthogonal to the second direction, in which the second carriage 14CG moves in order to discharge the shaping liquid.

The three-dimensional shaping apparatus 1 may also employ a configuration where the shaping head waiting position predetermined as the position where the shaping head 14 waits, and the layer forming unit waiting position predetermined as the position where the layer forming unit 13 waits, in the state where the shaping of the three-dimensional shaped object is not executed, are arranged at the opposite sides of the shaping stage 11S when viewed from the direction of gravity.

Also, the three-dimensional shaping apparatus 1 may further include the powder recovery unit 18 collecting the powder, and may employ a configuration where the upward and downward directions in the casing 10 are predetermined, the powder recovery unit 18 is open upward, and in the state where the shaping of the three-dimensional shaped object is not executed, the shaping head waiting position predetermined as the position where the shaping head 14 waits and the shaping stage 11S are arranged at the opposite sides of the powder recovery unit 18 when viewed from the direction of gravity.

The three-dimensional shaping apparatus 1 may further include the wiring cover 17 accommodating the second cable 14CL and the supply pipe 16.

The three-dimensional shaping apparatus 1 may also employ a configuration where the first cable 13CL and the second cable 14CL do not overlap the shaping stage 11S when viewed from the direction of gravity.

The three-dimensional shaping apparatus 1 may also employ a configuration where the casing 10 has the first surface M1 where the first groove C1 for guiding the movement of the first cable 13CL and the second groove C2 for guiding the movement of the second cable 14CL are formed, the first surface M1 is a surface parallel to the direction of gravity, and the shortest distance between the second coupling position PT24 where the second cable 14CL and the shaping head 14 are coupled together and the first surface M1 is longer than the shortest distance between the first coupling position PT14 where the first cable 13CL and the layer forming unit 13 are coupled together and the first surface M1.

The three-dimensional shaping apparatus 1 may also employ a configuration where the first cable 13CL includes one or more turn-around portions where the direction in which the first cable 13CL extends is turned around in addition to the first turn-around portion PT12, and the radius of curvature of the one or more turn-around portions is equal to or greater than the radius of curvature of the first turn-around portion PT12.

The three-dimensional shaping apparatus 1 may also employ a configuration where the supply pipe 16 includes one or more turn-around portions where the direction in which the supply pipe 16 extends is turned around, in addition to the second turn-around portion PT22 of the supply pipe 16, of the portions of the supply pipe 16, and the radius of curvature of the one or more turn-around portions is equal to or greater than the radius of curvature of the second turn-around portion PT22, of the portions of the supply pipe 16.

### Modification Example 1 of Embodiment

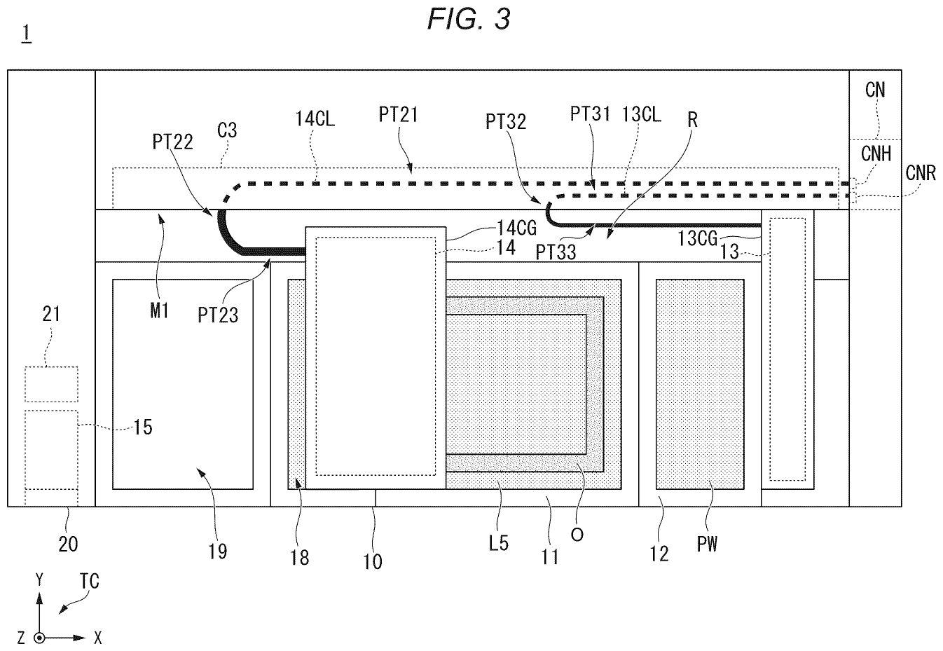

Modification Example 1 of the embodiment will now be described with reference to FIG. 3. FIG. 3 is a top view illustrating an example of the configuration of the three-dimensional shaping apparatus 1 according to Modification Example 1 of the embodiment. However, in FIG. 3, in order to clearly show the configuration of the three-dimensional shaping apparatus 1, the illustration is given in such a way that a part behind the top plate of the three-dimensional shaping apparatus 1 is visible.

In Modification Example 1 of the embodiment, the connector unit CN is provided in the plate-shaped member forming the side surface of the casing 10 in the second direction. Both the first connector CNR and the second connector CNH are provided in such a way as to protrude in the first direction. In the example shown in FIG. 3, the first groove C1 and the second groove C2 are formed as one groove C3 in the first surface M1. Both a part of the first cable 13CL and a part of the second cable 14CL are laid along the groove C3. As in the embodiment, the first surface M1 may have a configuration where two grooves, that is, the first groove C1 and the second groove C2, are formed.

As in the embodiment, the second cable 14CL and the supply pipe 16 have the first-direction extension portion PT21 extending in the first direction from the second connector CNH, the second turn-around portion PT22 where the direction in which the second cable 14CL and the supply pipe 16 extend is turned around, and the second-direction extension portion PT23 extending in the second direction from the second turn-around portion PT22. The first-direction extension portion PT21 is a portion laid along the groove C3, of the portions of the second cable 14CL and the supply pipe 16. Meanwhile, in this case, the first cable 13CL has a first-direction extension portion PT31 extending in the first from the first connector CNR, a first turn-around portion PT32 where the direction in which the first cable 13CL extends is turned around, and a second-direction extension portion PT33 extending in the second direction from the first turn-around portion PT32. However, in the first turn-around portion PT32, the first cable 13CL is turned around about an imaginary axis parallel or substantially parallel to the direction of gravity. The first-direction extension portion PT31 is a portion laid along the groove C3, of the portions of the first cable 13CL. That is, in the three-dimensional shaping apparatus 1 according to Modification Example 1 of the embodiment, both the first cable 13CL and the second cable 14CL extend in the first direction, then turn around, and extend in the second direction. Thus, in the three-dimensional shaping apparatus 1, the length of the first cable 13CL according to Modification Example 1 of the embodiment can be made shorter than the length of the first cable 13CL according to the embodiment. As a result, in the three-dimensional shaping apparatus 1, an increase in the manufacturing cost can be suppressed.

In FIG. 3, in order to clearly show each of the first-direction extension portion PT21 and the first-direction extension portion PT31, the first-direction extension portion PT21 and the first-direction extension portion PT31 are illustrated as not overlapping each other. However, when viewed from the direction of gravity, the first-direction extension portion PT21 and the first-direction extension portion PT31 may or may not overlap each other. When the first-direction extension portion PT21 and the first-direction extension portion PT31 overlap each other as viewed from the direction of gravity, the height of the lower end of the second cable 14CL in the direction of gravity is higher than the height of the upper end of the first cable 13CL in the direction of gravity, as in the three-dimensional shaping apparatus 1 illustrated in FIG. 1. Meanwhile, when the first-direction extension portion PT21 and the first-direction extension portion PT31 do not overlap with each other as viewed from the direction of gravity, the height of the lower end of the second cable 14CL in the direction of gravity may be higher than the height of the upper end of the first cable 13CL in the direction of gravity, or may be not higher than the height of the upper end of the first cable 13CL in the direction of gravity.

In the example shown in FIG. 3, too, the radius of curvature of the second turn-around portion PT22 of the second cable 14CL and the supply pipe 16 is larger than the radius of curvature of the first turn-around portion PT32 of the first cable 13CL. Therefore, in the three-dimensional shaping apparatus 1 according to Modification Example 1 of the embodiment, too, the amount of the shaping liquid stored in the liquid storage unit 15 can be increased, the user can easily take out the three-dimensional shaped object, and the flow path cross-sectional area of the supply pipe 16 can be suppressed from decreasing according to the movement of the shaping head 14.

In the three-dimensional shaping apparatus 1 shown in FIG. 3, the connector unit CN may be provided outside the plate-shaped member forming the side surface of the casing 10 in the second direction. In this case, the connector unit CN is provided in the groove C3, for example.

### Modification Example 2 of Embodiment

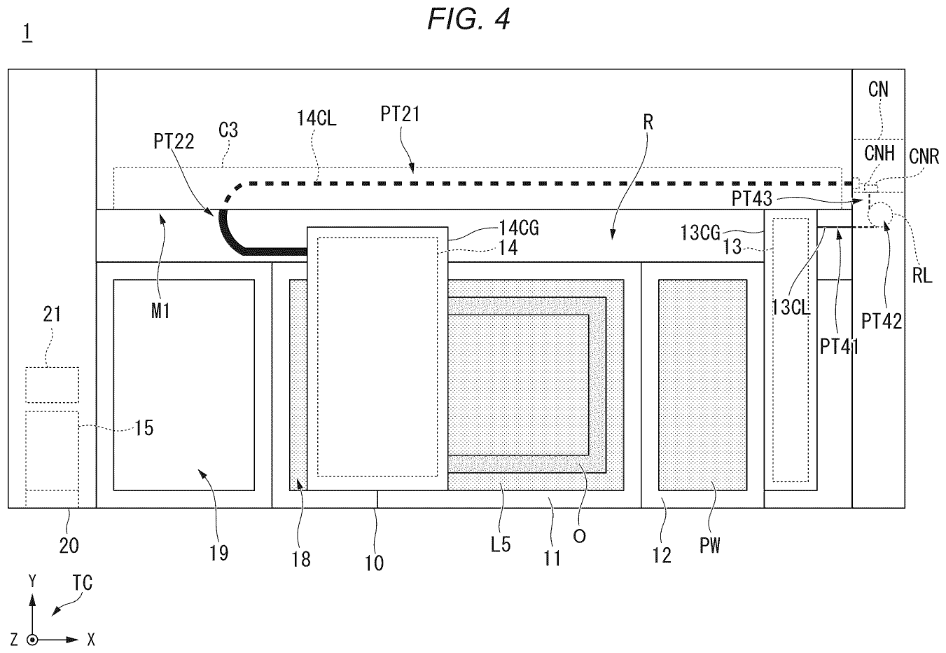

Modification Example 2 of the embodiment will now be described with reference to FIG. 4. Modification Example 2 of the embodiment is a modification example of Modification Example 1 of the embodiment. FIG. 4 is a top view illustrating an example of the configuration of the three-dimensional shaping apparatus 1 according to Modification Example 2 of the embodiment. However, in FIG. 4, in order to clearly show the configuration of the three-dimensional shaping apparatus 1, the illustration is given in such a way that a part behind the top plate of the three-dimensional shaping apparatus 1 is visible.

In Modification Example 2 of the embodiment, the configurations of the first surface M1 and the second cable 14CL are the same as those described in Modification Example 1 of the embodiment. Meanwhile, in Modification Example 2 of the embodiment, the first cable 13CL includes an extendable reel RL. The extendable reel RL is a reel that winds at least a part of the first cable 13CL according to the movement of the layer forming unit 13 in the second direction and unwinds the first cable 13CL according to the movement of the layer forming unit 13 in the first direction. Therefore, the first cable 13CL includes a second-direction extension portion PT41 extending in the second direction from the layer forming unit 13, a first turn-around portion PT42 where the direction in which the first cable 13CL extends is turned around, and a third-direction extension portion PT43 extending in the third direction from the first turn-around portion PT32. However, in the first turn-around portion PT42, the first cable 13CL is turned around about an imaginary axis parallel or substantially parallel to the direction of gravity. The third direction is a direction from the extendable reel RL toward the connector unit CN, of two directions orthogonal to both the first direction and the direction of gravity. The first turn-around portion PT42 is a portion taken up on the extendable reel RL, of the portions of the first cable 13CL. In this case, the radius of curvature of the first turn-around portion PT42 is the minimum radius of curvature, of the radii of curvature of the first cable 13CL taken up on the extendable reel RL.

In the three-dimensional shaping apparatus 1 according to Modification Example 2 of the embodiment, the length of the first cable 13CL can be shortened more securely since the first cable 13CL includes the extendable reel RL. In the example shown in FIG. 4, too, the radius of curvature of the second turn-around portion PT22 of the second cable 14CL and the supply pipe 16 is larger than the radius of curvature of the first turn-around portion PT42 of the first cable 13CL. Therefore, in the three-dimensional shaping apparatus 1 according to Modification Example 2 of the embodiment, too, the amount of the shaping liquid stored in the liquid storage unit 15 can be increased, the user can easily take out the three-dimensional shaped object, and the flow path cross-sectional area of the supply pipe 16 can be suppressed from decreasing according to the movement of the shaping head 14.

### Modification Example 3 of Embodiment

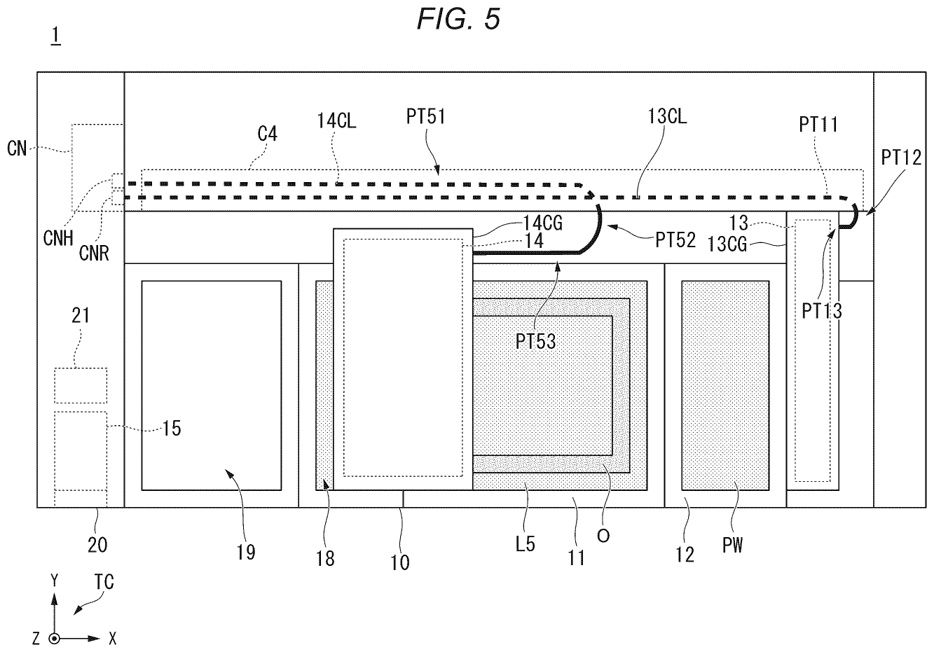

Modification Example 3 of the embodiment will now be described with reference to FIG. 5. FIG. 5 is a top view illustrating an example of the configuration of the three-dimensional shaping apparatus 1 according to Modification Example 3 of the embodiment. However, in FIG. 5, in order to clearly show the configuration of the three-dimensional shaping apparatus 1, the illustration is given in such a way that a part behind the top plate of the three-dimensional shaping apparatus 1 is visible.

In Modification Example 3 of the embodiment, the connector unit CN is provided in the plate-shaped member forming the side surface of the casing 10 in the first direction. The plate-shaped member is a member where each of the liquid storage unit 15, the display unit 20, and the control unit 21 is provided, in the three-dimensional shaping apparatus 1. In Modification Example 3 of the embodiment, both the first connector CNR and the second connector CNH are provided in such a way as to protrude in the second direction. In the example shown in FIG. 5, the first groove C1 and the second groove C2 are formed as one groove C4 in the first surface M1. Both a part of the first cable 13CL and a part of the second cable 14CL are laid along the groove C4. As in the embodiment, the first surface M1 may have a configuration where two grooves, that is, the first groove C1 and the second groove C2, are formed. As in the embodiment, the first cable 13CL includes the second-direction extension portion PT11 extending in the second direction from the first connector CNR, the first turn-around portion PT12 where the direction in which the first cable 13CL extends is turned around, and the first-direction extension portion PT13 extending in the first direction from the first turn-around portion PT12. The second-direction extension portion PT11 is a portion laid along the groove C4, of the portions of the first cable 13CL. Meanwhile, in this case, the second cable 14CL and the supply pipe 16 have a second-direction extension portion PT51 extending in the second direction from the second connector CNH, a second turn-around portion PT52 where the direction in which the second cable 14CL and the supply pipe 16 extend is turned around, and a first-direction extension portion PT53 extending in the first direction from the second turn-around portion PT52. However, in the second turn-around portion PT52, the second cable 14CL and the supply pipe 16 are turned around about an imaginary axis parallel or substantially parallel to the direction of gravity. The second-direction extension portion PT51 is a portion laid along the groove C4, of the portions of the second cable 14CL and the supply pipe 16. That is, in the three-dimensional shaping apparatus 1 according to Modification Example 3 of the embodiment, each of the first cable 13CL, the second cable 14CL, and the supply pipe 16 extends in the second direction, then turns around, and extends in the first direction. Accordingly, in the three-dimensional shaping apparatus 1, the length of the second cable 14CL according to Modification Example 3 of the embodiment can be made shorter than the length of the second cable 14CL according to the embodiment, and the length of the supply pipe 16 according to Modification Example 3 of the embodiment can be made shorter than the length of the supply pipe 16 according to the embodiment. As a result, in the three-dimensional shaping apparatus 1, an increase in the manufacturing cost can be suppressed and a noise can be suppressed from disturbing the control of the shaping head 14. In addition, in the three-dimensional shaping apparatus 1, since the supply pipe 16 can be shortened, the shaping liquid can be suppressed from staying in the supply pipe 16 for some reasons.

In FIG. 5, in order to clearly show each of the second-direction extension portion PT11 and the second-direction extension portion PT51, the second-direction extension portion PT11 and the second-direction extension portion PT51 are illustrated as not overlapping each other. However, when viewed from the direction of gravity, the second-direction extension portion PT11 and the second-direction extension portion PT51 may or may not overlap each other. When the second-direction extension portion PT11 and the second-direction extension portion PT51 overlap each other as viewed from the direction of gravity, the height of the lower end of the second cable 14CL in the direction of gravity is higher than the height of the upper end of the first cable 13CL in the direction of gravity, as in the three-dimensional shaping apparatus 1 illustrated in FIG. 1. Meanwhile, when the second-direction extension portion PT11 and the second-direction extension portion PT51 do not overlap with each other as viewed from the direction of gravity, the height of the lower end of the second cable 14CL in the direction of gravity may be higher than the height of the upper end of the first cable 13CL in the direction of gravity, or may be not higher than the height of the upper end of the first cable 13CL in the direction of gravity.

In the example shown in FIG. 5, too, the radius of curvature of the second turn-around portion PT52 of the second cable 14CL and the supply pipe 16 is larger than the radius of curvature of the first turn-around portion PT12 of the first cable 13CL. Therefore, in the three-dimensional shaping apparatus 1 according to Modification Example 3 of the embodiment, too, the amount of the shaping liquid stored in the liquid storage unit 15 can be increased, the user can easily take out the three-dimensional shaped object, and the flow path cross-sectional area of the supply pipe 16 can be suppressed from decreasing according to the movement of the shaping head 14.

In the three-dimensional shaping apparatus 1 shown in FIG. 5, the connector unit CN may be provided outside the plate-shaped member forming the side surface of the casing 10 in the first direction. In this case, the connector unit CN is provided in the groove C4, for example.

### Modification Example 4 of Embodiment

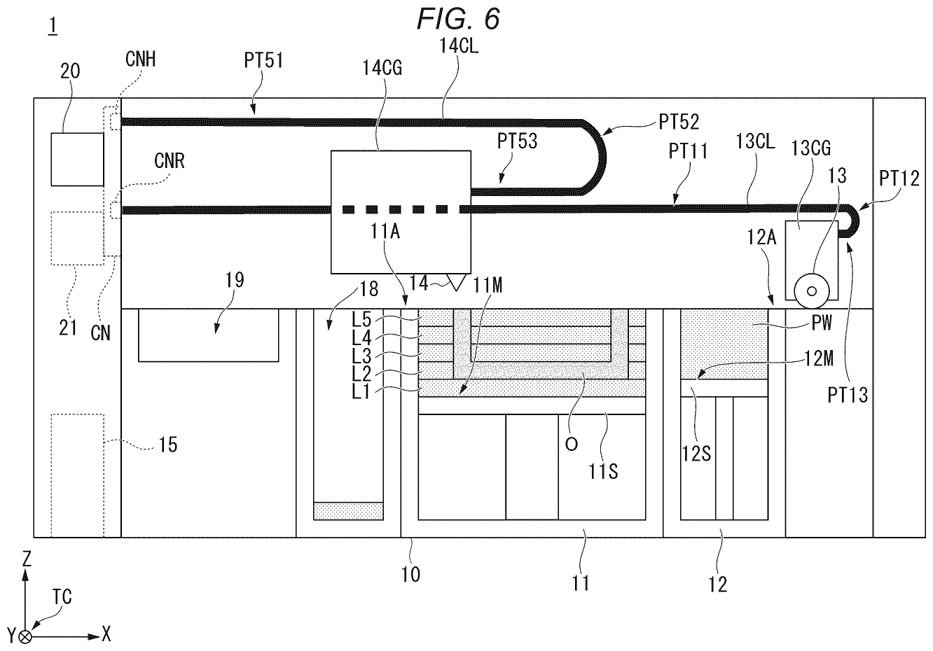

Modification Example 4 of the embodiment will now be described with reference to FIG. 6. Modification Example 4 of the embodiment is a modification example of Modification Example 3 of the embodiment. FIG. 6 is a front view illustrating an example of the configuration of the three-dimensional shaping apparatus 1 according to Modification Example 4 of the embodiment. However, in FIG. 6, in order to clearly show the configuration of the three-dimensional shaping apparatus 1, the illustration is given in such a way that a part of the inside of the three-dimensional shaping apparatus 1 is visible.

In Modification Example 4 of the embodiment, at least one of the first turn-around portion PT12 and the second turn-around portion PT52 is turned around about another imaginary axis instead of being turned around about the imaginary axis parallel to the direction of gravity. In the example shown in FIG. 6, both the first turn-around portion PT12 and the second turn-around portion PT52 are turned around about an imaginary axis parallel to a direction orthogonal to the first direction and the direction of gravity. More specifically, in the first turn-around portion PT12, the first cable 13CL is turned around in such a way that the second-direction extension portion PT11 is located above the first-direction extension portion PT13 in the direction of gravity. In the second turn-around portion PT52, the second cable 14CL is turned around in such a way that the second-direction extension portion PT51 is located above the first-direction extension portion PT53 in the direction of gravity. Thus, in the three-dimensional shaping apparatus 1 according to Modification Example 4 of the embodiment, for example, the size of the three-dimensional shaping apparatus 1 in the direction of depth can be reduced. In addition, in the three-dimensional shaping apparatus 1, for example, the user can be restrained from coming into contact with the first cable 13CL and the second cable 14CL when taking out the three-dimensional shaped object from the three-dimensional shaping region. This leads to an improvement in the convenience for the user.

In the example shown in FIG. 6, too, the radius of curvature of the second turn-around portion PT52 of the second cable 14CL and the supply pipe 16 is larger than the radius of curvature of the first turn-around portion PT12 of the first cable 13CL. Therefore, in the three-dimensional shaping apparatus 1 according to Modification Example 4 of the embodiment, too, the amount of the shaping liquid stored in the liquid storage unit 15 can be increased, the user can easily take out the three-dimensional shaped object, and the flow path cross-sectional area of the supply pipe 16 can be suppressed from decreasing according to the movement of the shaping head 14.

In the examples shown in FIGS. 1 to 6, the first cable 13CL is coupled to the layer forming unit 13 in a direction parallel to the first direction, but may be coupled in another direction instead.

In the examples shown in FIGS. 1 to 6, the second cable 14CL is coupled to the shaping head 14 in a direction parallel to the first direction, but may be coupled in another direction instead.

Further, the contents described above may be combined in any manner.

### APPENDIX

[1]

A three-dimensional shaping apparatus includes: a casing having a first connector and a second connector; a shaping stage to which powder is supplied and at which a powder layer is formed; a layer forming unit that forms a powder layer at the shaping stage; a first carriage that moves the layer forming unit relatively to the shaping stage; a shaping head that discharges a liquid containing a binder onto the powder layer formed at the shaping stage; a liquid storage unit that is provided in the casing and stores the liquid; a supply pipe that couples the liquid storage unit and the shaping head; a second carriage that moves the shaping head relatively to the shaping stage; a first cable that couples the first connector and the layer forming unit; and a second cable that couples the second connector and the shaping head, wherein the first cable has a first turn-around portion where a direction in which the first cable extends is turned around, the supply pipe has a second turn-around portion where a direction in which the supply pipe extends is turned around, and a radius of curvature of the second turn-around portion is larger than a radius of curvature of the first turn-around portion.

[2]

In the three-dimensional shaping apparatus according to [1], the second turn-around portion, the first carriage, and the second carriage are arranged in order of the second turn-around portion, the second carriage, and the first carriage when viewed from a direction orthogonal to a direction in which the second carriage moves in order to discharge the liquid.

[3]

In the three-dimensional shaping apparatus according to [1] or [2], in a state where shaping of a three-dimensional shaped object is not executed, a shaping head waiting position predetermined as a position where the shaping head waits, and a layer forming unit waiting position predetermined as a position where the layer forming unit waits, are arranged at opposite sides of the shaping stage when viewed from a direction of gravity.

[4]

The three-dimensional shaping apparatus according to any one of [1] to [3] further includes a powder recovery unit that collects the powder, wherein an upward direction and a downward direction in the casing are predetermined, the powder recovery unit is open upward, and in a state where shaping of a three-dimensional shaped object is not executed, a shaping head waiting position predetermined as a position where the shaping head waits and the shaping stage are arranged at opposite sides of the powder recovery unit when viewed from a direction of gravity.

[5]

The three-dimensional shaping apparatus according to any one of [1] to [4] further includes a wiring cover that accommodates the second cable and the supply pipe.

[6]

In the three-dimensional shaping apparatus according to any one of [1] to [5], the first cable and the second cable do not overlap the shaping stage when viewed from a direction of gravity.

[7]

In the three-dimensional shaping apparatus according to any one of [1] to [6], the casing has a first surface on which a first groove that guides movement of the first cable and a second groove that guides movement of the second cable are formed, the first surface is a surface parallel to a direction of gravity, and a shortest distance between a second coupling position where the second cable and the shaping head are coupled together, and the first surface, is longer than a shortest distance between a first coupling position where the first cable and the layer forming unit are coupled together, and the first surface.

[8]

In the three-dimensional shaping apparatus according to any one of [1] to [7], the first cable has a third turn-around portion where a direction in which the first cable extends is turned around in addition to the first turn-around portion, and a radius of curvature of the third turn-around portion is equal to or greater than a radius of curvature of the first turn-around portion.

[9]

In the three-dimensional shaping apparatus according to any one of [1] to [8], the supply pipe includes a fourth turn-around portion where a direction in which the supply pipe extends is turned around in addition to the second turn-around portion, and a radius of curvature of the fourth turn-around portion is equal to or greater than a radius of curvature of the second turn-around portion.

While the embodiment of the present disclosure has been described in detail with reference to the drawings, the specific configuration thereof is not limited to the embodiment and may be changed, replaced, deleted, or the like without departing from the spirit and scope of the present disclosure.

What is claimed is:

1. A three-dimensional shaping apparatus comprising:
a casing having a first connector and a second connector;
a shaping stage to which powder is supplied and at which a powder layer is formed;
a layer forming unit that forms a powder layer at the shaping stage;
a first carriage that moves the layer forming unit relatively to the shaping stage;
a shaping head that discharges a liquid containing a binder onto the powder layer formed at the shaping stage;
a liquid storage unit that is provided in the casing and stores the liquid;
a supply pipe that couples the liquid storage unit and the shaping head;
a second carriage that moves the shaping head relatively to the shaping stage;
a first cable that couples the first connector and the layer forming unit; and
a second cable that couples the second connector and the shaping head, wherein
the first cable has a first turn-around portion where a direction in which the first cable extends is turned around,
the supply pipe has a second turn-around portion where a direction in which the supply pipe extends is turned around, and
a radius of curvature of the second turn-around portion is larger than a radius of curvature of the first turn-around portion.

2. The three-dimensional shaping apparatus according to claim 1, wherein
the second turn-around portion, the first carriage, and the second carriage are arranged in order of the second turn-around portion, the second carriage, and the first carriage when viewed from a direction orthogonal to direction in which the second carriage moves in order to discharge the liquid.

3. The three-dimensional shaping apparatus according to claim 1, wherein
in a state where shaping of a three-dimensional shaped object is not executed, a shaping head waiting position predetermined as a position where the shaping head waits, and a layer forming unit waiting position predetermined as a position where the layer forming unit waits, are arranged at opposite sides of the shaping stage when viewed from a direction of gravity.

4. The three-dimensional shaping apparatus according to claim 1, further comprising:
a powder recovery unit that collects the powder, wherein
an upward direction and a downward direction within the casing are predetermined,
the powder recovery unit is open upward, and
in a state where shaping of a three-dimensional shaped object is not executed, a shaping head waiting position predetermined as a position where the shaping head waits and the shaping stage are arranged at opposite sides of the powder recovery unit when viewed from a direction of gravity.

5. The three-dimensional shaping apparatus according to claim 1, further comprising:
a wiring cover that accommodates the second cable and the supply pipe.

6. The three-dimensional shaping apparatus according to claim 1, wherein
the first cable and the second cable do not overlap the shaping stage when viewed from a direction of gravity.

7. The three-dimensional shaping apparatus according to claim 1, wherein
the casing has a first surface on which a first groove that guides movement of the first cable and a second groove that guides movement of the second cable are formed,
the first surface is a surface parallel to a direction of gravity, and
a shortest distance between a second coupling position where the second cable and the shaping head are coupled together, and the first surface, is longer than a shortest distance between a first coupling position where the first cable and the layer forming unit are coupled together, and the first surface.

8. The three-dimensional shaping apparatus according to claim 1, wherein
the first cable has a third turn-around portion where a direction in which the first cable extends is turned around in addition to the first turn-around portion, and
a radius of curvature of the third turn-around portion is equal to or greater than a radius of curvature of the first turn-around portion.

9. The three-dimensional shaping apparatus according to claim 1, wherein
the supply pipe includes a fourth turn-around portion where a direction in which the supply pipe extends is turned around in addition to the second turn-around portion, and
a radius of curvature of the fourth turn-around portion is equal to or greater than a radius of curvature of the second turn-around portion.
